(19) United States
(12) Patent Application Publication
(10) Pub. No.: US 2011/0085341 A1
(43) Pub. Date: Apr. 14, 2011

(54) DUAL CHAMBER PASSIVE COOLING SYSTEM FOR LED LAMP

(75) Inventor: William D. Little, JR., Corinth, TX (US)

(73) Assignee: The Brinkmann Corporation, Dallas, TX (US)

(21) Appl. No.: 12/900,298

(22) Filed: Oct. 7, 2010

Related U.S. Application Data
(60) Provisional application No. 61/250,324, filed on Oct. 9, 2009.

(51) Int. Cl. F21V 29/00; F21V 21/00; F28D 15/00

(52) U.S. Cl. 362/294; 362/382; 165/104.11

(57) ABSTRACT

The present invention is embodied an a dual-chamber passive cooling system for a light-emitting diode (LED) lamp and in a lighting fixture comprising such a system. The system comprises a printed circuit board (PCB) having a hole formed therein and extending through the PCB, and a shell defining a recess configured to receive the PCB. An LED may be positioned on one side of the PCB. The PCB is a thermally conductive PCB, such as a metal-core or graphite-core PCB, and is positioned within the recess so that it divides the recess into a first chamber defining a first volume and a second chamber defining a second volume that is less than the first volume. The shell has a first opening formed therein proximate the first chamber and a second opening formed therein proximate the second chamber, so that air can flow into and out of the chambers, cooling the LED and PCB through convection.

### CROSS-REFERENCE TO RELATED APPLICATION

The present application claims priority to U.S. Provisional Application No. 61/250,324, entitled “Dual Chamber Passive Cooling System for LED Lamp,” filed Oct. 9, 2009, the entire contents of which are herein incorporated by reference.

### FIELD OF THE INVENTION

The present invention pertains to the field of light-emitting diode (“LED”) lamps and, more particularly, to passive cooling systems for LED lamps.

### BACKGROUND OF THE INVENTION

LED-based illumination systems, including LED-based illumination systems for indoor track lighting fixtures, have commonly included one or more LEDs contained within a housing capable of transmitting electromagnetic radiation from the LED(s) in the form of visible light. By varying the semiconductor materials used in the LED(s) and/or by adding a phosphor material to the housing, a variety of light colors may be produced, including white light, amber light, and yellow light.

In the past, LED lamps have used 5-millimeter “lamp style” LEDs that lacked a means for managing the temperature of the lamp. More recently, LED lamp manufacturers have employed newer, higher-power LEDs that require a heat sink. The bulk of these newer LEDs have used a conventional, passive heat sink attached at the rear of the lamp to the thermal pads of the LEDs. These heat sinks are typically made of die-cast aluminum and are generally heavy, large, and expensive to manufacture. The weight of the heat sink can cause an undesirable cantilever effect in track lighting fixtures.

Accordingly, there is a need for a cost-effective approach to managing the temperature of LED lamps that minimizes the cantilever effect in track lighting fixtures. The present invention satisfies this and other needs, and provides further related advantages.

### SUMMARY OF THE INVENTION

The present invention resides in a dual-chamber passive cooling system for an LED lamp and in a lighting fixture comprising such a system. The system comprises a printed circuit board (PCB) having a hole formed therein and extending through the PCB, and a shell defining a recess configured to receive the PCB. An LED may be positioned on one side of the PCB. The PCB is a thermally conductive PCB, such as a metal-core or graphite-core PCB, and is positioned within the recess so that it divides the recess into a first chamber defining a first volume and a second chamber defining a second volume that is less than the first volume. The shell has a first opening formed therein and extending into the first chamber, and a second opening formed therein and extending into the second chamber, so that air can flow into and out of the chambers, cooling the LED and PCB through convection.

In one embodiment, the printed circuit board has a plurality of holes formed therein and extending through the printed circuit board. The printed circuit board comprises an aluminum core approximately three millimeters thick.

In another embodiment, the shell has a first plurality of openings formed therein and extending into the first chamber, and a second plurality of openings formed therein and extending into the second chamber. The shell has a substantially hemispherical shape having an apex and a longitudinal axis extending through the apex. The openings of the first plurality of openings are latitudinally arranged in a ring about the longitudinal axis of the shell, and are longitudinally positioned proximate the printed circuit board. The openings of the second plurality of openings are latitudinally arranged in a ring about the longitudinal axis of the shell, and are longitudinally positioned proximate the apex of the shell. The printed circuit board has a plurality of holes formed therein and extending through the printed circuit board, and the total area bounded by the plurality of holes differs from the total area bounded by the second plurality of openings.

The lighting fixture of the present invention comprises a dual-chamber passive cooling system and an LED positioned on one side of the PCB. The LED may be covered by a lens positioned within the recess and configured to focus, compress, shape, diffuse, or spread out light emitted by the LED. A ring-shaped cover may be attached to a bottom portion of the shell for retaining the lens and printed circuit board within the shell. A bi-pin, wedge, or other standard lamp base may be electrically connected to the LED via the printed circuit board.

In one embodiment, each side of the printed circuit board has an area greater than or equal to approximately 1.25 square inches per watt used by the LED.

Other features and advantages of the invention will become apparent from the following detailed description of the preferred embodiments taken with the accompanying drawings, which illustrate, by way of example, the principles of the invention.

### BRIEF DESCRIPTION OF THE DRAWINGS

Embodiments of the present invention will now be described, by way of example only, with reference to the following drawings.

FIG. 1 is a perspective view of an LED lighting fixture having a dual-chamber passive cooling system, in accordance with an embodiment of the present invention.

FIG. 2 is an exploded perspective view of the fixture of FIG. 1.

FIG. 3 is a side elevation view of the fixture of FIG. 1.

FIG. 4 is a bottom plan view of the fixture of FIG. 1.

FIG. 5 is a top plan view of the fixture of FIG. 1.

FIG. 6 is a sectional view of the fixture of FIG. 1, taken along the plane indicated by the broken line 6-6 in FIG. 5, showing the convection currents through the fixture in an embodiment.

FIG. 7 is an exploded sectional view of the fixture of FIG. 1, taken along the plane indicated by the broken line 6-6 in FIG. 5.

FIG. 8 is a first diagrammatic plan view of a PCB for the fixture of FIG. 1, showing the electrical traces for the PCB.

FIG. 9 is a second diagrammatic plan view of the PCB of FIG. 8, showing the solder mask and print for the PCB.

### DETAILED DESCRIPTION OF THE PREFERRED EMBODIMENTS

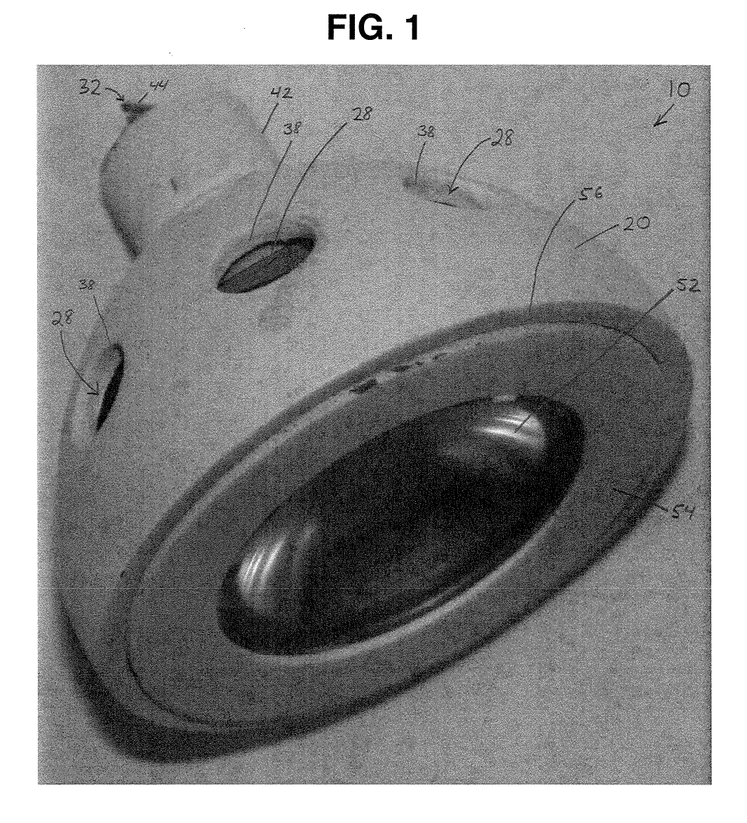

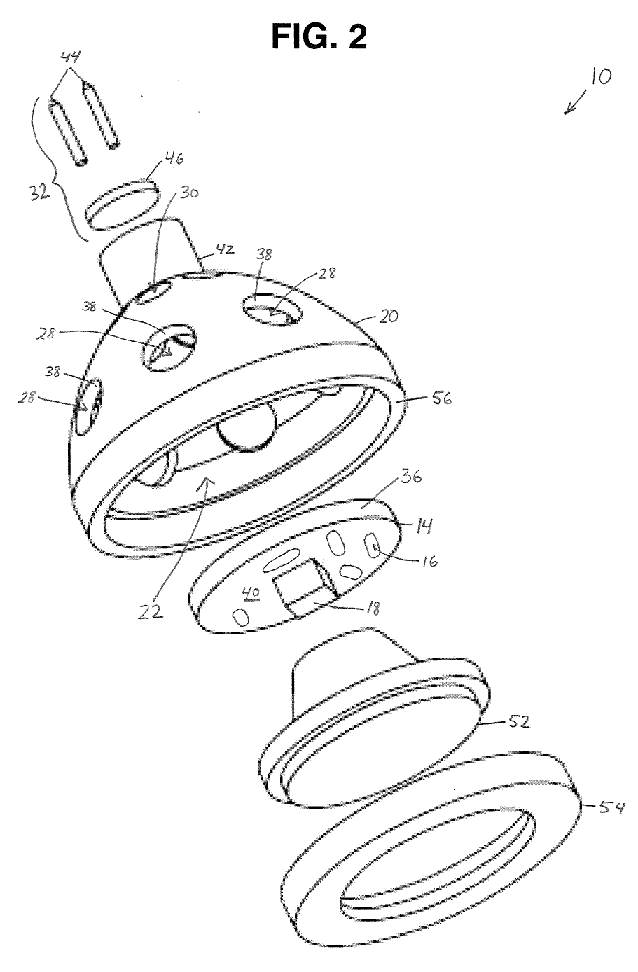

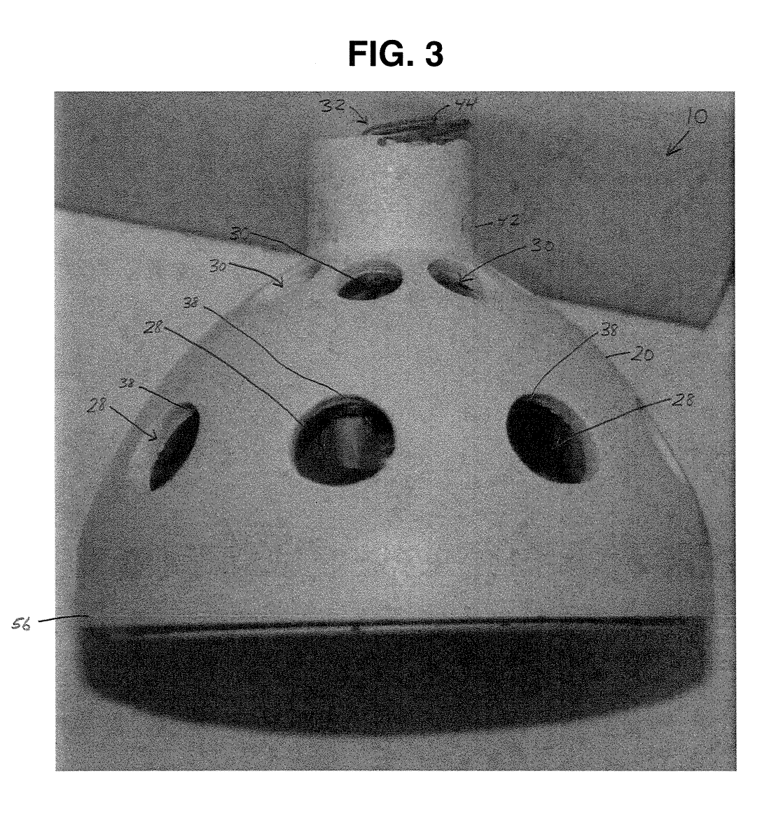

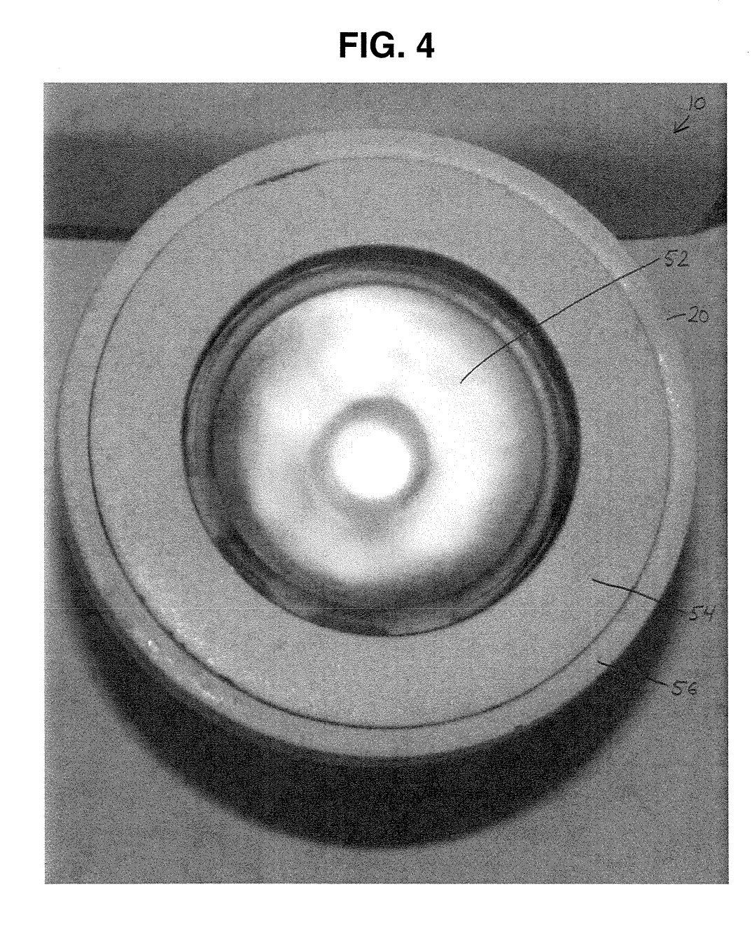

Referring now to the drawings, and particularly to FIGS. 1-7 thereof, there is shown an LED lighting fixture 10 having a dual-chamber passive cooling system, in accordance with an embodiment of the present invention. The fixture comprises a thermally conductive PCB 14 having a plurality of holes 16 formed therein and extending through the PCB, an LED 18 positioned on one side of the PCB, and a shell 20 defining a recess 22 configured to receive the PCB. The PCB provides a heat-spreading effect and a means for increasing the exposed surface area for cooling the dice within the LED. The PCB is positioned within the recess so that it divides the recess into a first chamber 24 defining a first volume and a second chamber defining 26 a second volume that is less than the first volume. The shell has a first set of openings 28 formed therein proximate the first chamber and a second set of openings 30 formed therein proximate the second chamber, so that air can flow into and out of the chambers, cooling the LED and PCB through convection.

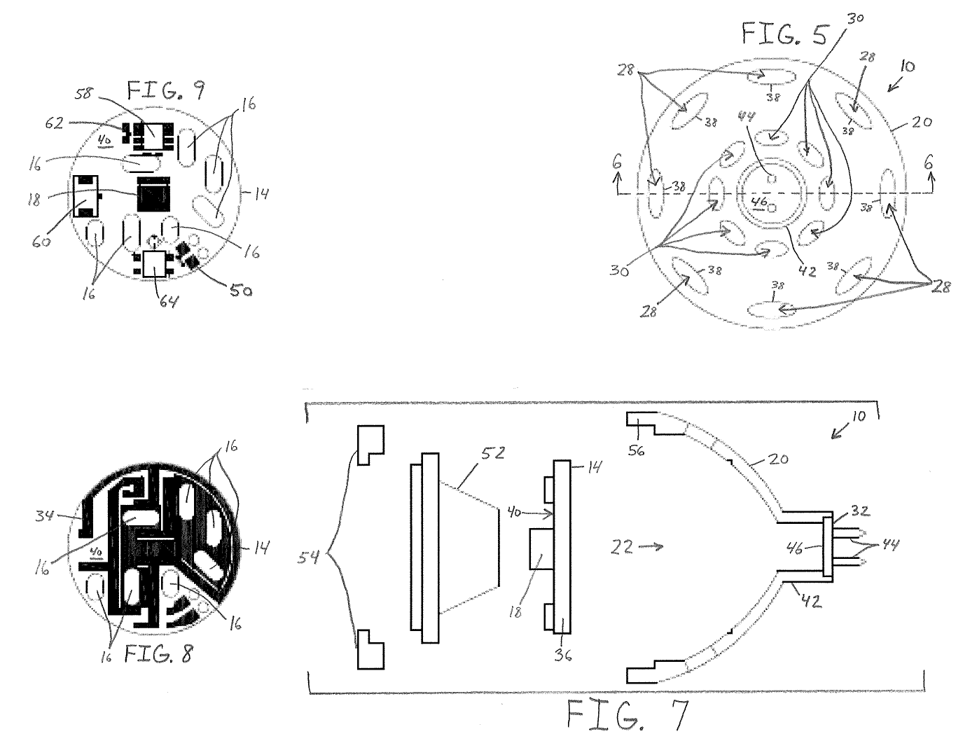

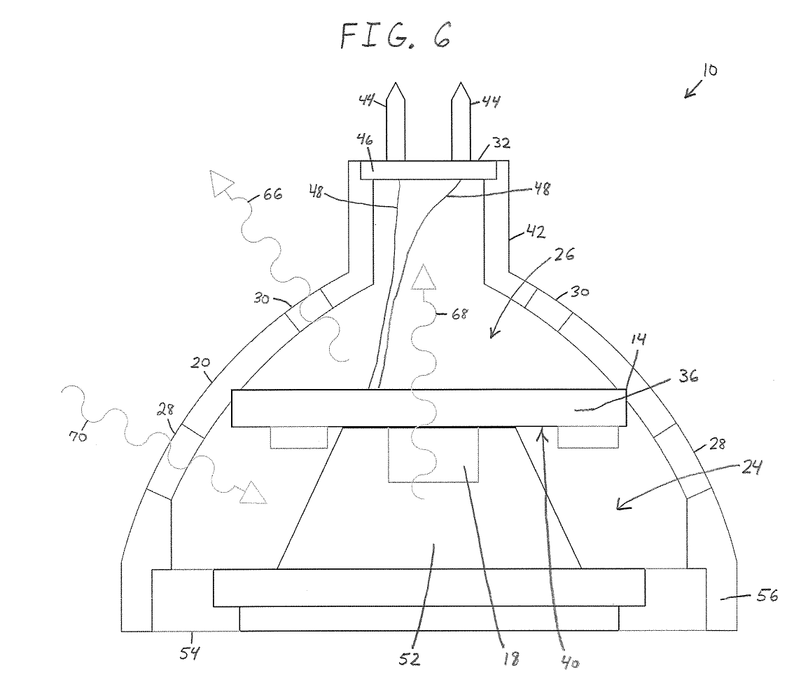

The PCB 14 mechanically supports the LED 18 and electrically connects it to a bi-pin base 32 via conductive pathways or traces 34 (see FIG. 8), which may be etched from 4-ounce copper sheets laminated onto a non-conductive substrate. The PCB may be generally disk-shaped and have a thick (approximately 3 millimeter) core 36 comprising a metal (such as aluminum), graphite, and/or another thermally conductive material. In one embodiment, each side of the PCB disk has a minimum area of approximately 1.25 square inches per watt used by the LED. A white solder mask (see FIG. 9) may be applied over the traces to provide a protective coating for the traces and to reflect light that might impinge upon the PCB. The holes 16 may be configured as shown in FIGS. 8 and 9.

In one embodiment, the LED 18 is a blue LED that emits a dark blue light. The LED may be encapsulated within a phosphor casing positioned on the PCB 14. The casing absorbs at least some of the light emitted by the blue LED and re-emits it in a broad range of wavelengths, producing white light. In a particular embodiment, the casing encapsulates InGaN blue LEDs. A suitable phosphor material for the casing is cerium-doped yttrium aluminium garnet (Ce³⁺:YAG). In another embodiment, instead of a single LED, the PCB has an LED array, such as a C5050-WT-TR 3-by-3 LED array.

The shell 20 comprises acrylonitrile butadiene styrene (ABS) generally molded into the shape of a hemisphere having an axis a. The hemisphere defines the recess 22, which is sized to receive the PCB 14. The PCB acts as a partition, dividing the recess into the larger first chamber 24 and smaller second chamber 26. The first set of openings 28 formed in the shell opens into the first chamber. In one embodiment, there are eight generally circular openings 28 latitudinally arranged in a ring about the hemisphere axis and longitutinally positioned so that the topmost portion 38 of each opening is approximately at the level of the bottom 40 of the PCB. The second set of openings 30 formed in the shell opens into the second chamber. In one embodiment, there are eight generally circular or slightly elliptical openings 30 latitudinally arranged in a ring about the hemisphere axis and longitutinally positioned proximate the apex 42 of the shell.

The apex 42 of the shell 20 may be molded into the shape of a generally circular cylinder sized to receive the bi-pin base 32. The bi-pin base comprises two small pins 44 extending from a plastic retainer 46. The pins may be connected to the PCB 14 by wires 48 soldered to an AC receptacle 50 (see FIG. 9) on the PCB. In one embodiment, the bi-pin base complies with a standard from the International Electrotechnical Commission for lamp fittings, so that the lighting fixture 10 can fit into existing lamp receptacles. In other embodiments, a wedge base or other standard lamp base may be used.

The LED 18 may be covered by a lens 52 configured to focus, compress, shape, diffuse, or spread out light emitted by the LED. In one embodiment, the lens is a C10684_Eva-D or C10685_Eva-M lens sold by LEDIL OY of Finland. The lens and PCB 14 may be retained within the shell 20 by a ring-shaped cover 54 configured to be attached to a bottom portion 56 of the shell.

With reference to FIGS. 8 and 9, there is shown diagrammatic plan views of the PCB 14 in accordance with an embodiment of the present invention. FIG. 8 shows the traces 34 for the PCB. FIG. 9 shows the solder mask and print for the PCB. The LED 18 may be driven by an ON Semiconductor NUD4001DR2G high-current LED driver 58 made by ON Semiconductor of Phoenix, Ariz. The PCB 14 may also comprise a Vishay 293D107X9020E2TE3 solid tantalum surface mount capacitor (20V, 100 μF) 60 made by Vishay Intertechnology, Inc. of Malvern, Pa., an 0805-size, ⅛ W, 6-ohm resistor 62, and a Diodes HD04 0.8A surface-mount glass-passivated bridge rectifier 64 made by Diodes Inc. of Dallas, Tex.

The holes 16 formed in the PCB 14 and openings 28 and 30 formed in the shell 20 allow air to into and out of the larger first chamber 24 and smaller second chamber 26, cooling the LED 18, LED driver 58, and PCB through convection. In operation, as the LED 18 heats up, the core 36 of the PCB heats up and warms the air in the two chambers. Because the second chamber is smaller, the air within the second chamber warms more quickly and undergoes greater thermal expansion than the air within the larger first chamber. The thermal expansion creates a passive airflow through the chambers and through the PCB, cooling the LED, LED driver, and PCB without the need for an additional die-cast heat sink.

With reference to FIG. 6, there is shown a sectional view of the lighting fixture 10, taken along the plane indicated by the broken line 6-6 in FIG. 5, showing convection currents 66, 68 and 70 through the fixture in an embodiment. The direction of the convention currents largely depends upon the sizes of the holes 16 formed in the PCB 14 and the openings 30 formed in the shell 20. FIG. 6 shows an embodiment wherein the total area bounded by the holes formed in the PCB is less than the total area bounded by the openings 30 formed in the shell and extending into the smaller second chamber 26. In this embodiment, the warmed air within the smaller second chamber is encouraged to escape through the openings 30, setting up the convection current 66. The escape of air through the openings 30 creates a passive airflow, drawing air from the larger first chamber 24 into the smaller second chamber through the holes formed in the PCB (convection current 68) and drawing air from outside the shell into the first chamber through the openings 28 (convection current 70). The direction of the convention currents would be reversed in an embodiment wherein the total area bounded by the holes formed in the PCB is greater than the total area bounded by the openings 30 formed in the shell and extending into the smaller second chamber.

The present invention thus can be configured to provide a cost-effective means of managing the temperature of LED lamps that minimizes the cantilever effect in track lighting fixtures.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A passive cooling system for an LED lamp, the cooling system comprising:
a printed circuit board having a hole formed therein and extending through the printed circuit board; and
a shell defining a recess configured to receive the printed circuit board;
wherein the printed circuit board is positioned within the recess so that the printed circuit board divides the recess into a first chamber defining a first volume and a second chamber defining a second volume that is less than the first volume; and
wherein the shell has
an opening formed therein and extending into the first chamber, and
an opening formed therein and extending into the second chamber.

2. The passive cooling system of claim 1, wherein the printed circuit board has a plurality of holes formed therein and extending through the printed circuit board.

3. The passive cooling system of claim 1, wherein the printed circuit board comprises a metal core.

4. The passive cooling system of claim 3, wherein the metal core is approximately three millimeters thick.

5. The passive cooling system of claim 3, wherein the metal core comprises aluminum.

6. The passive cooling system of claim 1, wherein the shell has:
a first plurality of openings formed therein and extending into the first chamber; and
a second plurality of openings formed therein and extending into the second chamber.

7. The passive cooling system of claim 6, wherein the shell has a substantially hemispherical shape having an apex and a longitudinal axis extending through the apex.

8. The passive cooling system of claim 7, wherein the openings of the first plurality of openings are latitudinally arranged in a ring about the longitudinal axis of the shell.

9. The passive cooling system of claim 8, wherein the openings of the first plurality of openings are longitudinally positioned proximate the printed circuit board.

10. The passive cooling system of claim 7, wherein the openings of the second plurality of openings are latitudinally arranged in a ring about the longitudinal axis of the shell.

11. The passive cooling system of claim 10, wherein the openings of the second plurality of openings are longitudinally positioned proximate the apex of the shell.

12. The passive cooling system of claim 5, wherein:
the printed circuit board has a plurality of holes formed therein and extending through the printed circuit board; and
the total area bounded by the plurality of holes differs from the total area bounded by the second plurality of openings.

13. A lighting fixture having a passive cooling system, the lighting fixture comprising:
a printed circuit board having a hole formed therein and extending through the printed circuit board;
an LED positioned on one side of the printed circuit board; and
a shell defining a recess configured to receive the printed circuit board;
wherein the printed circuit board is positioned within the recess so that the printed circuit board divides the recess into a first chamber defining a first volume and a second chamber defining a second volume that is less than the first volume; and
wherein the shell has
an opening formed therein and extending into the first chamber, and
an opening formed therein and extending into the second chamber.

14. The lighting fixture of claim 13, wherein the printed circuit board comprises a metal core.

15. The lighting fixture of claim 13, wherein each side of the printed circuit board has an area greater than or equal to approximately 1.25 square inches per watt used by the LED.

16. The lighting fixture of claim 13, wherein the shell has:
a first plurality of openings formed therein and extending into the first chamber; and
a second plurality of openings formed therein and extending into the second chamber.

17. The lighting fixture of claim 16, wherein the shell has a substantially hemispherical shape having an apex and a longitudinal axis extending through the apex.

18. The lighting fixture of claim 17, wherein the openings of the first plurality of openings are latitudinally arranged in a ring about the longitudinal axis of the shell.

19. The lighting fixture of claim 18, wherein the openings of the first plurality of openings are longitudinally positioned proximate the printed circuit board.

20. The lighting fixture of claim 17, wherein the openings of the second plurality of openings are latitudinally arranged in a ring about the longitudinal axis of the shell.

21. The lighting fixture of claim 20, wherein the openings of the second plurality of openings are longitudinally positioned proximate the apex of the shell.

22. The lighting system of claim 16, wherein:
the printed circuit board has a plurality of holes formed therein and extending through the printed circuit board; and
the total area bounded by the plurality of holes differs from the total area bounded by the second plurality of openings.

23. The lighting fixture of claim 13, further comprising a lens positioned within the recess and covering the LED.

24. The lighting fixture of claim 23, further comprising a ring-shaped cover attached to a bottom portion of the shell for retaining the lens and printed circuit board within the shell.

25. The lighting fixture of claim 13, further comprising a bi-pin base electrically connected to the LED via the printed circuit board.
